(19) United States
(12) Patent Application Publication
(10) Pub. No.: US 2006/0287951 A1
(43) Pub. Date: Dec. 21, 2006

(54) Data reading device with multiple verification functions and verifications system thereof

(76) Inventors: Gigi Chen, Taipei (TW); Ko Li Chao, Taipei (TW); Kuo Sen Hsueh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/206,831

(22) Filed: Aug. 19, 2005

(30) Foreign Application Priority Data
Jun. 15, 2005 (TW) 094119821

(51) Int. Cl. G06Q 99/00; H04L 9/00; H04K 1/00; G06Q 40/00

(52) U.S. Cl. 705/39; 705/62

(57) ABSTRACT

A data accessing device with multiple verification functions and a verification system are provided. The device comprises an electronic certificate reader and a radio frequency signal reader in an outer housing. The electronic certificate reader can access an electronic certificate displayed in a portable electronic device of a user through an optical path, while the radio frequency signal reader accesses a personal radio frequency identification label of a user through a radio frequency path. The electronic certificate data and personal radio frequency identification label data is sent to a verification system to be processed and compared with user data stored in a user database to determine whether the access electronic certificate and personal radio frequency identification label are correct or whether there is a corresponding relationship therebetween. Accordingly, comparison result data is generated which can be represented in a result review device to be benefit for an identity verification application system to know correct identity of the user or whether to continue proceeding the transaction.

### FIELD OF THE INVENTION

The present invention is related to a data accessing device, and more particularly to a data accessing device with multiple verification functions and a verification system thereof, which is used for an identity verification application system to know correct identity of the user or whether to continue proceeding the transaction.

### BACKGROUND

By the increasing development of the society and financial industry, the number of credit transaction can be called a new force suddenly coming to the force. In various credit transaction, the consuming mode of using plastic money, such as credit card, etc., is widely adopted by general consumers due to its convenience and has become main transaction mode in daily shopping products.

The prior art transaction mode of credit card is shown in FIG. 1, which comprises main transaction steps of:

Step 101 and step 112: the user must apply a credit card for representing the user to at least one authorization unit, such as bank, financial organization or trading company. User data (personal data) of the user is stored in a certified management unit (or financial information center), and the user can keep the credit card;

Step 103: when the user wants to proceed a shopping transaction, the personal owned credit card is given to a sale end (trading company), and the sale end uses a card sliding machine to input consuming data, such as consuming amount of money and so on;

Step 105: place the credit into the card sliding machine to proceed the card sliding operation to read the credit card data;

Step 107: the card sliding machine transmits transaction data, such as credit card data, consuming amount of money, card sliding machine number (i.e. sale end number), and card sliding time and so on to the certified management unit, which compares the credit card data with the stored user data. If the data is correct after comparison, an authorization code is obtained;

Step 109: after the sale end gets the authorization code, the credit card receipt (or payment receipt) is printed out, and the user signs it and exchanges shopped products to complete the transaction of the shopped products.

The above mentioned prior art shopping method of credit card has been accepted by consumers and widely used in general credit card transaction occasions. Nevertheless, in the above mentioned shopping method, the user's credit card has to be placed in the card sliding machine of the sale end to proceed the card sliding operation and accessing credit card data. In this process, it is very possible to cause the credit card data recorded or stolen by unworthy personages, and fake card is further made to proceed embezzling. It easily causes shopping dispute, as well as the issuing bank or user losing money or damaging goodwill. Further, when the user forgets to carry a wallet or credit cards, an awkward situation of unable to pay is often caused too.

Therefore, seeking for another easier and safer electronic transaction mode or faster and certain user identity confirmation mechanism is always expected by all financial industries and consumers. Since portable electronic devices, such as cell phones, are common in use and have portability, they are treated as one of the options by industries. However, although the portable electronic devices, such as cell phones, have portability, the safety, speed, and personal identify identification label thereof is doubted by the masses. Therefore, the technology of using cell phone as a product transaction media is still needed to be developed.

Additionally, a technology of a cell phone attached with a radio frequency identification label (RFID) appeared in market, which mainly uses the identification label speed of RFID to increase the usage types of cell phones by which other functions other than product consuming can be proceeded. However, the existed technology of cell phones attached with a radio frequency identification label is placing the RFID on the cell phone mother board or subscriber identity module (SIM card) which is generally controlled and authorized by cell phone manufacturer or telecommunication industries. For financial organizations or general trading companies, they do not have much autonomy, and thus the motive power to push into the market is lacked. Besides, since RFID is directly provided on the cell phone motherboard or SIM card, it is dangerous to safety and privacy of the customers.

### SUMMARY OF THE INVENTION

Accordingly, how to design a data accessing device to be suitable for use in novel electronic transaction modes and a verification system thereof which not only avoids from the risk of credit card being embezzled, but also has safety, speed, and privacy with respect to the previous mentioned shortcomings of the prior art is the key point of the present invention. Therefore,

It is a primary object of the present invention to provide a data accessing device for accessing an electronic certificate representing financial organizations or trading companies and a personal radio frequency identification label and a verification system to quickly determine the correct identity of the user and decide whether to continue proceeding the transaction. Therefore, the trade safety and convenience of electronic transaction can be improved.

It is a secondary object of the present invention to provide a data accessing device which can further provides at least one third signal processor according to the safety needs and access at least one biological feature signal input by the user as a further basis to ensure the user identity. This way, the safety of the transaction can be further improved.

It is another object of the present invention to provide a verification system, which can simultaneously access and determine electronic certificate and personal radio frequency identification label representing a financial institution, trading company, product object, or user individual to quickly determine correct identity of the user or decide whether the transaction can be continuously proceeded. Therefore, the trade safety and convenience of electronic transaction can be improved.

It is another object of the present invention to provide a verification system whose personal radio frequency identification label and electronic certificate can be independently authorized by financial institutions, government organizations, or trading companies without limiting by cell phone manufacturing industries or telecommunication industries to completely meet standard modes of existed consuming habits and consuming laws. This way, the promotion of usage in market can be improved.

To achieve the previous mentioned objects, the present invention provides a data accessing device with multiple verification functions which mainly comprises an electronic certificate reader and a radio frequency signal reader respectively connected to a verification system, wherein the electronic certificate reader accesses at least one electronic certificate by an optical path, the radio frequency reader accesses at least one personal radio frequency identification label by a radio frequency path, and the electronic certificates and the radio frequency identification label are respectively sent to the verification system to be proceeded data processing.

Further, to achieve the above mentioned objects, the present invention further provides a verification system with multiple verification functions which mainly comprises: a data accessing device at least comprising an electronic certificate reader for accessing at least one electronic certificate and a radio frequency signal reader for accessing at least one personal radio frequency identification label, and the electronic certificate processed to become electronic certificate data and the personal radio frequency identification label processed to become radio frequency identification label data; a data processing device electrically connected to the data accessing device which at least comprises an optical signal processor for processing the electronic certificate data and a radio frequency signal processor for processing the radio frequency identification label data; and a data comparison device connected to the data processing device for receiving the electronic certificate data and the radio frequency identification label data and accordingly determining a corresponding relationship between the electronic certificate and the personal radio frequency identification label to generate a comparison result data.

### BRIEF DESCRIPTION OF DRAWINGS

FIG. 1 is a flow chart of the transaction in a prior art credit card transaction system.

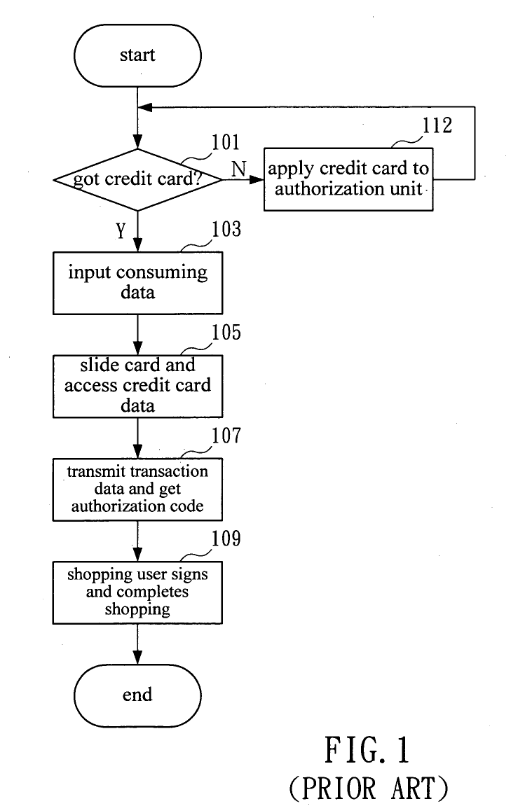

FIG. 2 is a structural diagram of a verification system of the present invention in use.

FIG. 3 is a flow chart of the verification system of the present invention in use.

FIG. 4 is a structural diagram of a preferred embodiment of the verification system of the present invention.

FIG. 5 is a structural cross sectional diagram of an embodiment of the data accessing device of the present invention.

FIG. 6 is a structural diagram of an alternate embodiment of the verification system of the present invention.

### DETAILED DESCRIPTION

The structural features and the effects to be achieved may further be understood and appreciated by reference to the presently preferred embodiments together with the detailed description.

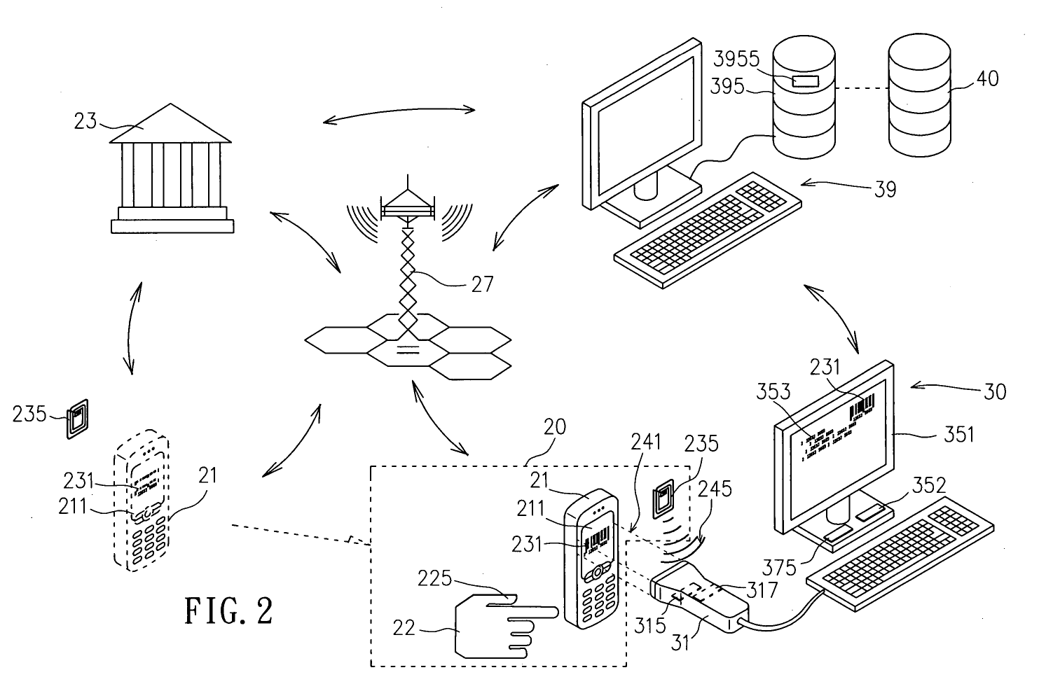

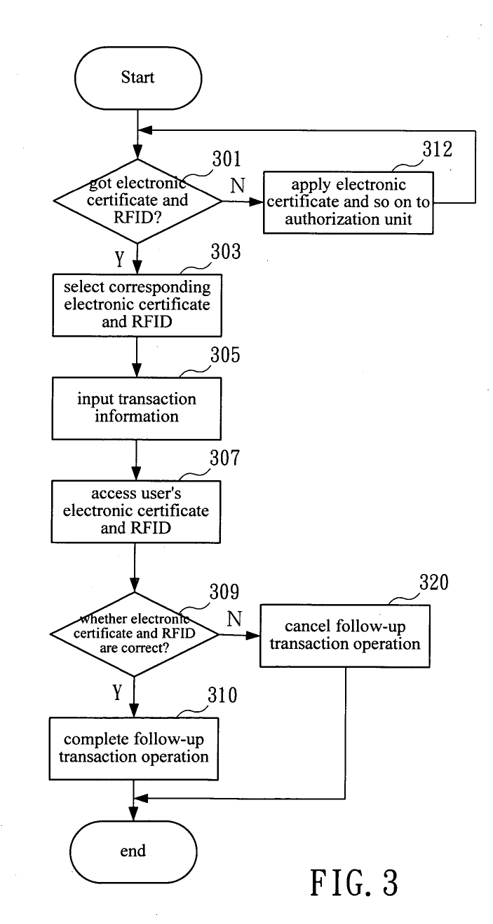

Firstly, refer to FIG. 2 together with FIG. 3, respectively a structural diagram and flow chart of a verification system of the present invention in use. As shown, the electronic transaction system suitable of using data accessing device and verification system of the present invention comprises at least one authorization unit 23, at least one portable electronic device 21, at least one verification system 30, and a user database 395 (or called as a certified management unit 39). Among them, the authorization unit 23, such as a bank, financial institution, government organization, community organization, or trading company, can accept the application of at least one user 22 to selectively make or generate at least one electronic certificate 231, at least one personal radio frequency identification label (RFID) 235, or a combination of the electronic certificate 231 and personal radio frequency identification label 235. User data 3955 associated with the electronic certificate 231 and personal radio frequency identification label 235 can be transmitted directly or via a telecommunication device 27 to be stored in the user database 395, as shown in step 301 and step 312.

Among them, the electronic certificate 231 can be used to represent the authorization unit 23 or to represent shopping certificate of shopped products or service which can comprise at least the data of the authorization unit or connection data with the user database 395 therein, and the electronic certificate 231 can be directly or via the telecommunication device 27, such as GSM system, CDMA system, DAMPS system, FLEX system, CDPD system, PDC system, CT2 system, DECT system, PACS system, PHS system, GPRS system, or physical network, sent to the portable electronic device 21 to be stored therein and displayed on the display screen 211 of the portable electronic device 21. Therefore, the electronic certificate 231 can be represented as valid signs, such as a barcode, multimedia messaging service (MMS), short message service (SMS), WAP pull/push, optical character recognize (OCR), symbol, or numeral and so on. Further, the personal radio frequency identification label 235 can represent user individual identity, which can at least comprise personal data of the user or the connection data with the user database 395 therein. The electronic certificate 231, personal radio frequency identification label 235, or user 22 can be mutually combined to a personal user system 20.

When the user wants to proceed a shopping transaction or an identity confirmation, he/she can select to hold the personal radio frequency identification label 235 authorized by one of the authorization unit 23 and collocate with corresponding electronic certificate 231 stored in the portable electronic device 21, as shown in step 303.

When the user completes picking out and buying products and wants to pay up and slide the credit card, a verification system 30, such as a sale end (trading company), will finish the electronic transaction operations. As with the prior art transaction mode, the verification system 30 is input transaction information, such as transaction amount of money, product name, or quantity, and so on as shown in step 305.

The verification system 30 can comprise a data accessing device 31 which can comprise at least one electronic certificate reader 315 and a radio frequency signal reader 317 therein. Among them, the electronic certificate reader 315 can access the electronic certificate 231 in the portable electronic device 21 via an infrared rays path (signal) or optical path 241, while the radio frequency signal reader 317 accesses the personal radio frequency identification label 235 in the personal user system 20 by a radio frequency path (signal) 245, as shown in step 307.

The read input electronic certificate 231 could be displayed on the display 351 to provide the sale end or verification system 30 a simple determination and cue. For example, prompt which bank authorized the electronic certificate 231 hold by the user? Whether the valid date is correct? Or there is any other matter needed to attend to?

Further, after verification system 30 accessing data on the electronic certificate 231 and personal radio frequency identification label 235, it can determine whether the read electronic certificate 231 and the personal radio frequency identification label 235 match with each other by itself. If not, then stop the follow-up transaction. Of course, after accessing the electronic certificate 231 or the personal radio frequency identification label 235, the verification system 30 can connect to the user database 395 via a telecommunication device 27 according to the access data to compare with the user data 3955 stored therein to determine whether the hold electronic certificate 231 and personal radio frequency identification label 235 are correct, as shown in step 309.

If the access electronic certificate 231 and personal radio frequency identification label 235 match with each other in the comparison process, and the electronic certificate 231 and personal radio frequency identification label 235 were not notified to be stopped or cancelled, it means legal usage. The follow-up transaction operation should be able to be continued proceeding. For example, input transaction amount of money, input a sale end number 352, grant products, grant transaction certificate, or cancel transaction and so on, as shown in step 310.

Of course, if the access electronic certificate 231 and personal radio frequency identification label 235 are found out unmatched with each other in the comparison process, or one of the electronic certificate 231 and personal radio frequency identification label 235 was notified to be stopped or cancelled, then immediately stop the follow-up transaction operation, as shown in step 320.

The comparison result data 353 generated in the comparison process can be shown in the result review device 375 of the verification system 30 which can be a speaker or display 351. Further, the comparison result data 353 can also be provided to an identity verification application system 40 to be used which can be selected as a payment system, financial system, government organization, or sale end trading company.

Further, the electronic certificate 231 can be selected as a shopping certificate, (bus or train) ticket, plane ticket, ticket voucher, concert ticket, discounted price ticket, authorization unit, exchange certificate, or trade object.

Since the trade mode suitable in the present invention uses the authorization unit 23 to authorize the electronic certificate 231 and personal radio frequency identification label 235, the credit card authorization unit and steps are the same as those existed without limiting in having to tie in the cell phone manufacturing industries or telecommunication industries. Therefore, there is no problem in popularizing in market or acceptability. Besides, since the personal radio frequency identification label 235 of the present invention can be separated from the portable electronic device 21, when the user does not plan on shopping and consuming, he/she does not have to carry around or fix it on the portable electronic device 21, and thus preventing the third party from knowing the user's location by an illegitimate scanning way to maintain the usage privacy of the user.

Further, in various embodiments of the present invention, the electronic certificate 231 can represent not only the authorization unit 23 or the shopping certificate of shopped products or services, but also personal user identity. The personal radio frequency identification label 235 can represent not only user individual identity, but also the authorization unit 23 or the shopping certificate of shopped products or services.

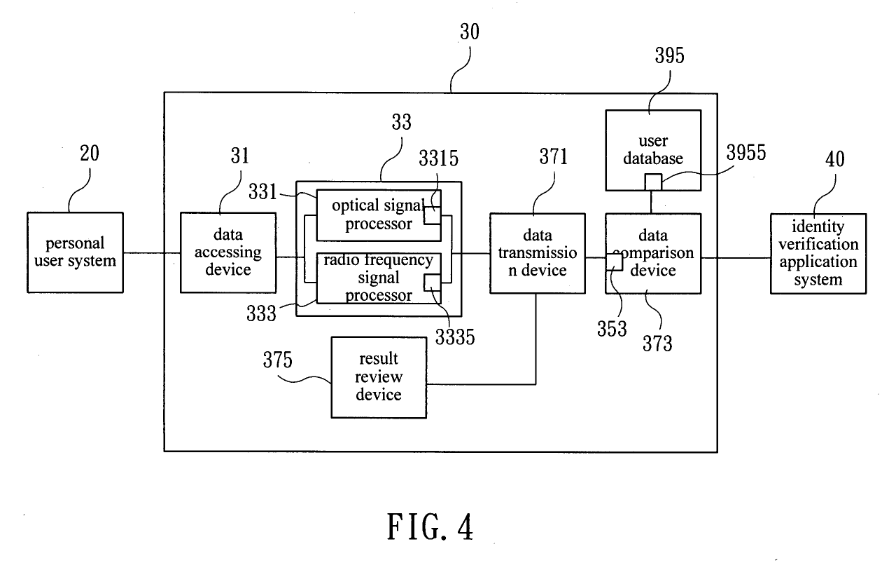

Moreover, please refer FIG. 2 and FIG. 4 simultaneously, structural diagrams of a preferred embodiment of the verification system of the present invention. As shown, in addition to the data accessing device 31, the verification system 30 of the present invention can further comprise a data processing device 33 connected to the data accessing device 31. The data processing device 33 can at least comprise an optical signal processor 331 and a radio frequency signal processor 333. Among them, the optical signal processor 331 can receive the electronic certificate 231 from the electronic certificate reader 315 and transform it into electronic certificate data 3315, while the radio frequency signal processor 333 can receive the personal radio frequency identification label 235 from the radio frequency signal reader 317 and transform it into radio frequency identification label data 3335.

Further, the processed electronic certificate data 3315 and radio frequency identification label data 3335 can be sent to a data comparison device 373 by a data transmission device 371, such as the telecommunication device (27). The data comparison device 373 can be also connected to the user database 395 and obtain the user data 3955 related to the electronic certificate data 3315 or radio frequency identification label data 3335 stored in the user database 395. Next, the electronic certificate data 3315, radio frequency identification label data 3335, and user data 3955 is used to determine whether the electronic certificate 231 and personal radio frequency identification label 235 in the personal user system 20 are correct or have relationship to generated comparison result data 353.

Further, the comparison result data 353 can be sent back to the verification system 30 through the data transmission device 371 and shown in the result review device 375 connected with the data comparison 373 or data transmission device 371 by voice or images to provide the identity verification application system 40, such as the sale end trading company connected to the verification system 30, to be used and be a determinant in user identity verification or deciding whether to continue proceeding the transaction.

Further, although in the above mentioned embodiment, the certified management unit 39 and user database 395 are separated from the verification system 30, in an alternate embodiment of the present invention, the certified management unit 39 or user database 395 can be also fixed in the verification system 30. This way, it is convenient to proceed the product transaction.

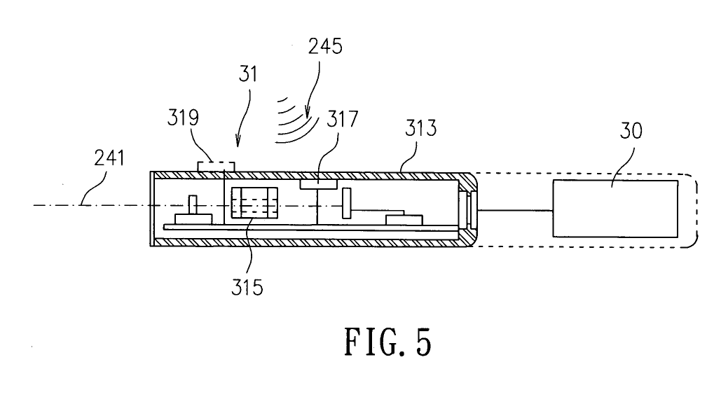

In addition, please refer to FIG. 5, a structural cross sectional diagram of an embodiment of the data accessing device of the present invention. As shown, in this embodiment, the electronic certificate reader 315 and radio frequency signal reader 317 can be both structured and arranged in an outer housing 313 to become a data accessing device 31 and connected to a verification system 30. In various embodiments, the data accessing device 31 can also be a part of the verification system 30 and arranged in a body, as shown in dotted lines.

Further, in an alternate embodiment, a third signal reader 319 can be further provided in the data accessing device 31 with respect to the real safety needs; for example, an image capturer (camera lens), a voice capturer (microphone), or a symbol key and so on. The third signal reader 319 can access at least one biological feature signal 225 from the user (22 as shown in FIG. 2), such as fingerprint, pupil, blood vessel, voice, or input symbol, numeral, character, valid sign and so on. This way, the safety mechanism of the user identity verification is strengthened.

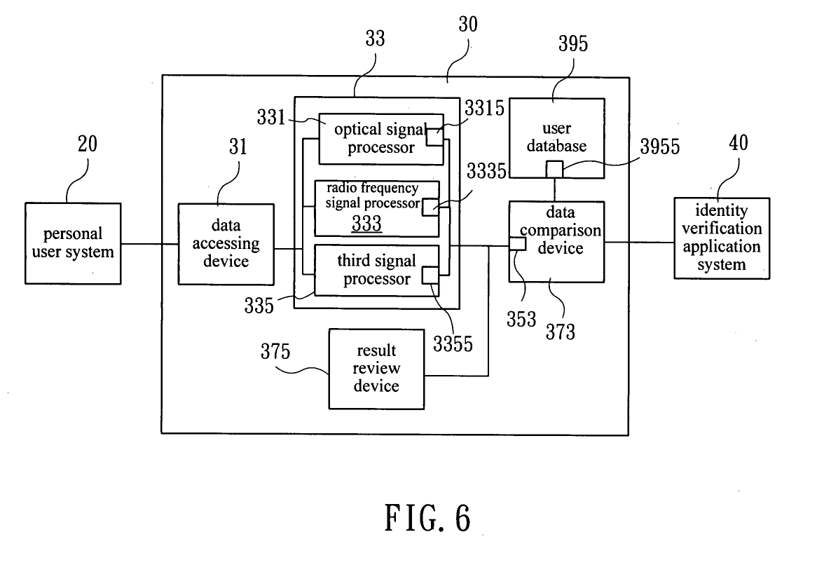

Finally, please refer to FIG. 6, a structural diagram of another embodiment of the verification system of the present invention. As shown, in this embodiment, the data processing device 33 further has a third signal processor 335 operating in coordination with the above mentioned third signal reader (319) in the former embodiment. The third signal processor 335 processes the biological feature signal (225) from the third signal reader (319) and transforms it into third data 3355 which can be sent to the data comparison device 373. Together with the electronic certificate data 3315, radio frequency identification label data 3335, and user data 3955, it is synthesized and compared to determine whether the real identity of the user is correct or has relationship to generate the comparison result data 353.

In this embodiment, the verification system 30 can be arranged in the same position. Therefore, the data processing device 33 can be directly connected to the data comparison device 373, and the electronic certificate data 3315, radio frequency identification label data 3335, or third data 3355 is directly sent to the data comparison device 373 to be compared and processed without needing the data transmission device (371) shown in the embodiment in FIG. 4. The same object of improving the trade safety and convenience of the electronic transactions of the present invention can be achieved as well.

While the personal radio frequency identification label (RFID) 235 of the present invention can be authorized by the issuing unit 23 alone and can be separated from the portable electronic device 21 anytime to be beneficial to popularizing in market, usage safety, convenience, and privacy, the personal radio frequency identification label 235 can also be selectively fixed or placed in the portable electronic device 21 for carrying convenience, such as attaching to inside of the battery cover, on the outer housing of the portable electronic device 21, or hanging on the portable electronic device 21 to become a hanging decoration, to prevent from the awkward situation of not carrying the personal radio frequency identification label 235 thus unable to consume.

In various embodiments of the present invention, the personal radio frequency identification label 235 can also be directly fixed on the motherboard or subscriber identity module (SIM card) (not shown) in the portable electronic device 21. Although such a structure has a risk of losing user's privacy, the object of product transaction safety can also be achieved as well by the double verification modes of the personal radio frequency identification label 235 and electronic certificate 231. The personal radio frequency identification label 235 can also be produced by cell phone industries authorized by general trading companies, or bought and used by the trading companies after produced by the cell phone industries by themselves, the above mentioned object of product transaction can also be achieved as well.

Further, the above mentioned portable electronic device 21 can be spoken without specific reference to electronic devices, such as a cell phone, portable computer, personal digital assistant, stock messenger, global satellite locator, video/audio player, or recording pen and so on.

In summary, it is appreciated that the present invention is related to a data accessing device, and more particularly to a data accessing device with multiple verification functions and a verification system thereof benefit for an identity verification application system to know correct identity of the user or decide whether to continue proceeding the transaction. Therefore, the present invention should be granted a patent.

The foregoing description is merely one embodiment of present invention and not considered as restrictive. All equivalent variations and modifications in process, method, feature, and spirit in accordance with the appended claims may be made without in any way from the scope of the invention.

### LIST OF REFERENCE SYMBOLS

20 personal user system
21 portable electronic device
211 display screen
22 user
225 biological feature signal
23 authorization unit
231 electronic certificate
235 personal radio frequency identification label
241 optical path
245 radio frequency path
27 telecommunication device
30 verification system
31 data accessing device
313 outer housing
315 electronic certificate reader
317 radio frequency signal reader
319 third signal reader
33 data processing device
331 optical signal processor
3315 electronic certificate data
333 radio frequency signal processor
3335 radio frequency identification label data
335 third signal processor
3355 third data
351 display
352 sale end number
353 comparison result data
371 data transmission device
373 data comparison device
375 result review device
39 certified management unit
395 user database
3955 user data
40 identity verification application system

1. A data accessing device with multiple verification functions comprising an electronic certificate reader and a radio frequency reader respectively connected to a verification system, wherein said electronic certificate reader accesses at least one electronic certificate via an optical path, said radio frequency reader accesses at least one personal radio frequency identification label via a radio frequency path, and said electronic certificates and said personal radio frequency identification label are respectively sent to said verification system for data processing.

2. The data accessing device according to claim 1, wherein said electronic certificate is selected as one of a barcode, multimedia messaging service, short message service, WAP pull/push, optical text identification signal, symbol, and numeral.

3. The data accessing device according to claim 1, wherein said electronic certificate is displayed on a display screen of a portable electronic device.

4. The data accessing device according to claim 1, wherein said electronic certificate is selected as one of a shopping certificate, (bus or train) ticket, plane ticket, ticket voucher, concert ticket, discounted price ticket, authorization unit, exchange certificate, and trade object.

5. The data accessing device according to claim 3, wherein said portable electronic device is selected as one of a cell phone, portable computer, personal digital assistant, stock messenger, globe satellite locator, video/audio player, and recording pen.

6. The data accessing device according to claim 1, wherein said electronic certificate reader and said radio frequency reader are simultaneously fixed in an outer housing.

7. The data accessing device according to claim 1 further comprising at least one third signal reader connected to said verification system for accessing at least one biological feature signal and sending said biological feature signals to said verification system.

8. The data accessing device according to claim 7, wherein said third signal reader is selected as one of an image capturer, voice capturer, and symbol key.

9. The data accessing device according to claim 7, wherein said biological feature signal is selected as one of a fingerprint, pupil, blood vessel, voice, symbol, numeral, character, and valid sign.

10. The data accessing device according to claim 1, wherein said verification system comprises a data processing device connected to a data comparison device, respectively connected to a user database and a result display device.

11. The data accessing device according to claim 10, wherein said data processing device is connected to said data comparison device by a data transmission device.

12. The data accessing device according to claim 10, wherein said data processing device is selected as one of an optical signal processor, a radio frequency signal processor, a third signal processor, and a combination thereof.

13. A verification system with multiple verification functions, comprising:
a data accessing device at least comprising an electronic certificate reader for accessing at least one electronic certificate and a radio frequency signal reader for accessing at least one personal radio frequency identification label, and respectively processing said electronic certificate to become an electronic certificate data, processing said personal radio frequency identification label to become a radio frequency identification label data;
a data processing device electrically connected to said data accessing device at least comprising an optical signal processor for processing said electronic certificate data, and a radio frequency signal processor for processing said radio frequency identification label data; and
a data comparison device connected to said data processing device for receiving said electronic certificate data and said radio frequency identification label data and accordingly determining a corresponding relationship between said electronic certificate and said personal radio frequency identification label to generate a comparison result data.

14. The verification system according to claim 13, wherein said data comparison device is further connected to a user database, receiving at least one user data stored in said user database, and generating said comparison result data according to said user data, said electronic certificate data, and radio frequency identification label data.

15. The verification system according to claim 13, wherein said data comparison device is connected to said data comparison by a data transmission device.

16. The verification system according to claim 13 further comprising a result review device connected to said data comparison device for representing said comparison result data.

17. The verification system according to claim 13, wherein said data accessing device further comprises a third signal reader for accessing at least one biological feature signal, said biological feature signal sent to a third signal processor of said data processing device for processing and accordingly generating a third data.

18. The verification system according to claim 17, wherein said third signal reader is selected as one of an image capturer, voice capturer, and symbol key.

19. The verification system according to claim 17, wherein said biological feature signal is selected as one of a fingerprint, pupil, blood vessel, voice, symbol, numeral, character, and valid sign.

20. The verification system according to claim 13, wherein said electronic certificate is displayed on a display screen of a portable electronic device.

21. The verification system according to claim 20, wherein said portable electronic device is selected as one of a cell phone, portable computer, personal digital assistant, stock messenger, globe satellite locator, video/audio player, and recording pen.

22. The verification system according to claim 13, wherein said electronic certificate and said personal radio frequency identification label are existed in a personal user system.

23. The verification system according to claim 13, wherein said comparison result data is also sent to an identity verification application system.

24. The verification system according to claim 13 further comprising an authorization unit for generating said electronic certification and said personal radio frequency identification label, wherein said authorization unit is selected as one of a financial institution, trading company, government organization, and social organization.

25. The verification system according to claim 13, wherein said electronic certificate is selected as one of a shopping certificate, (bus or train) ticket, plane ticket, ticket voucher, concert ticket, discounted price ticket, authorization unit, exchange certificate, and trade object.
